(19) United States
(12) Patent Application Publication
(10) Pub. No.: US 2007/0234205 A1
(43) Pub. Date: Oct. 4, 2007

(54) Defining virtual shapes to position text and graphics

(75) Inventors: Donald S. Lloyd, Point Reyes, CA (US); Bradley K. Nelson, Santa Rosa, CA (US); Phillip W. McGee, Chino Hills, CA (US); Wynn Bailey, Cloverdale, CA (US); Robert P. Lee, Cloverdale, CA (US); Klaus Albrecht, Munich (DE)

Correspondence Address: FULWIDER PATTON LLP, HOWARD HUGHES CENTER, 6060 CENTER DRIVE, TENTH FLOOR, LOS ANGELES, CA, 90045, US

(73) Assignee: Avery Dennison Corporation, Pasadena, CA (US)

(21) Appl. No.: 11/690,098

(22) Filed: Mar. 22, 2007

Related U.S. Application Data
(60) Provisional application No. 60/787,083, filed on Mar. 29, 2006.

(51) Int. Cl. G06F 17/00; G06T 1/00; G06T 11/20

(52) U.S. Cl. 715/520; 715/530; 715/531; 715/517; 715/521; 345/418; 345/441

(57) ABSTRACT

Virtual shapes are defined that are referenced to one or more actual, printable sheets for printing. The virtual shapes are referenced to the actual sheet using a rotation and x-axis (left-to-right) and y-axis (top-down) coordinates. The coordinates are typically specified with respect to the top-left corner of the sheet. In one example, an end-user views a shape on a display, such as a computer monitor, a kiosk screen, the screen of a personal data assistant or other digital device. The shape may correspond, for example, to a complex label shape. After the user has input customized and/or personalized text, graphics or other information to be printed, the software may apply a rotation to the virtual shape as it is referenced onto the actual page to be printed. A product identification table may be provided in order to correlate proper rotations and/or coordinates to particular types of commercial sheets. A single virtual shape may be referenced multiple times onto a single sheet. The virtual shape may be complex, such as a complex polygon and/or ellipse, and may include such features as cut-outs, blank areas to be kept free of text and/or graphics, multiple areas for printing text and/or graphics, as well as other complex features.

### CROSS-REFERENCE TO RELATED APPLICATION

This is a non-provisional utility patent application based on Provisional Application Ser. No. 60/787,083, filed Mar. 29, 2006 and titled, “DEFINING VIRTUAL SHAPES TO POSITION TEXT AND GRAPHICS,” from which priority is hereby claimed and which is hereby incorporated by reference.

### BACKGROUND OF THE INVENTION

For many years, a popular approach to defining a sheet for printing labels, tabs, cards and other related printable media, has used tables (columns and rows) in combination with pitch (a step-and-repeat process across and down the table). The table and pitch method is shown graphically in FIG. 1. A sheet 10 is represented in such terms as a side margin 12, top margin 14, vertical pitch 16, horizontal pitch 18, label width 20, label height 22, number across 24 and number down 26.

A printable media, for example, was a metrical sheet that could be defined in terms of columns and rows. In simple applications, the goal was to simply place text on a simple label shape. The table and pitch method worked adequately for placing text on these simple products.

A drawback with this approach, however, relates to placing graphics on the sheet. The table and pitch approach is not well adapted for defining where graphics are to be placed, and how they are to be placed on the sheet. Also, more complex shapes are now desired. These shapes may include curves, cut-outs, holes and may be of various sizes. Often, the desired shape is much more complex than a simple square or circle. The shape may be, for example, a starburst, an ellipse, or a complex label shape having cutouts. Other advanced shapes may include fold-ups for origami and crafts.

It is also often desired to specify areas on those complex shapes where text is to be printed, where graphics are to be printed, and the like. When the item to be designed is a complex shape other than a simple circle or rectangle, for example, the table and pitch method can be cumbersome and inadequate to define predefined areas. The table and pitch method is also not well suited for applications in which there are different shapes to be printed on one sheet, such as a label sheet on which there are different-shaped labels. Another problem relates to “creep” and “crawl” errors, in which inaccuracies introduced using the table and pitch method are multiplied when the error occurs several times on a page.

A separate challenge has been how to accommodate new formats with existing software. For example, existing software may coded to design and print a greeting card having a particular layout, such that text, graphics and the like are to be rotated a certain way and placed in a fixed position on the printed card. But then when a new type of card is developed, having a different layout, the existing software cannot accommodate the new card. Typically, a new version of the software must be released that will rotate and otherwise format the text and/or graphics in the proper manner with respect to the new card. It would be preferable to have a system in which new sheet designs could be supported by existing versions of the software on the fly, without having to make major rewrites to software.

What has been needed to this point is an approach for preparing text, graphics and the like for printing onto a sheet in a manner that overcomes these and/or related drawbacks. The invention disclosed herein meets these and other needs.

### SUMMARY OF THE INVENTION

The present invention provides an application-independent collection of page demarcation instructions that is more robust than the table and pitch method described above. Unlike the table and pitch method, these new instructions define virtual shapes that are independent of the sheet. These virtual shapes, which can also be called “panels,” can then be referenced to one or more actual sheets using x-axis (left-to-right) and y-axis (top-down) coordinates, with respect to the top-left corner of the sheet, as well as respective rotations. The virtual shapes are typically not actually printed on the sheet, but are a concept used in positioning other information such as text and/or graphics and/or other information to be printed onto a sheet in the proper position on a particular sheet product.

One aspect of the invention relates to a method for positioning text and/or graphics on a sheet. In this method, a virtual shape is defined. The virtual shape is then referenced to an actual sheet using coordinates and rotation.

The method may also include steps of displaying the virtual shape to an end-user in a first orientation. Then, after the user has optionally input and/or selected text, graphics or the like, the virtual shape is referenced to an actual sheet in a second orientation. This orientation is often different than the orientation of the shape when displayed to the user.

The virtual shape is not limited to simple rectangles and circles. The virtual shape may be a complex polygon, ellipse or other shape. The shape may include special areas, such as non-printing areas and/or cut-outs, and may even include various interior patterns.

Multiple virtual shapes may be defined, which are referenced to a sheet using respective coordinates and rotation. For example, a first virtual shape may have a first rotation and a second virtual shape may have a second rotation, the first rotation being different than the second rotation. Virtual shapes may be referenced more than once on the sheet to be printed, in repeating and/or other patterns.

In one implementation, a product list may be provided to identify individual printable media products. The system may correlate virtual shapes, coordinates and rotations with entries on the product list. In one mode of operation, an end user may identify a particular product from the product list. The user may also optionally input and/or select text and/or graphics to be included on the sheet to be printed. The system then references the virtual shape and or shapes and the input from the end user to the selected product. In this way, for example, a user can specify the type of sheet to be printed on, as well as what is to be printed on the sheet, and the system references the appropriate virtual shape or shapes in a manner appropriate to the particular sheet the user selects.

The invention may allow updating the system with new sheet types, including new sheet layouts, dimensions, and/or other changes. This can be done without updating the software code but can be accomplished instead, for example, by supplying new and/or updated sheet geometry to the existing software.

It is to be understood that the present invention is not limited to the specific examples described herein. Also, it should be understood that there are numerous features and variations that are described herein that form part of the invention. Consequently, the present invention is to be understood with reference to the detailed description below, the drawings, and the claims, and is not limited by this summary or by description of any one particular embodiment.

### BRIEF DESCRIPTION OF THE DRAWINGS

FIG. 1 illustrates an approach in which tables and pitch define a sheet for purposes of printing;

FIG. 2 illustrates a concept in accordance with the present invention in which virtual shapes and coordinates provide page demarcation instructions;

FIG. 3 illustrates examples of virtual shapes;

FIG. 4 illustrates the concept of rotation;

FIG. 5 illustrates different panel shapes, including internal shapes designating nonprintable areas;

FIG. 6 illustrates a panel that is larger than a single sheet;

FIG. 7 illustrates two panels that are assigned an order on a page;

FIG. 8 is an organizational diagram showing components of an embodiment of a system in accordance with the present invention;

FIG. 9 illustrates rotation of the front, back, inside left and inside right of a tall greeting card when presented for formatting (no rotation) and then for printing (rotation);

FIG. 10 illustrates an alternative to the template of FIG. 9, in which printing is presented for a “wide” greeting card;

FIG. 11 illustrates an example of a sheet of audiotape labels having multiple areas for text input and cutouts;

FIG. 12 illustrates an example of burst labels;

FIG. 13 illustrates an example of CD/DVD labels, spine labels and inserts;

FIG. 14 illustrates an example of mini-media labels having multiple virtual shapes for smartmedia, memory stick, SD card and compact flash labels;

FIG. 15 illustrates a sheet of round labels offset in each row; and

FIG. 16 illustrates one example of printing requirements for a particular printer.

### DETAILED DESCRIPTION OF THE PREFERRED EMBODIMENTS

As discussed above, the present invention relates to an application-independent collection of page demarcation instructions that is more robust than the table and pitch method described above. Unlike the table and pitch method, these new instructions define virtual shapes that are independent of the sheet. These virtual shapes, which can also be called “panels,” can then be referenced to one or more actual sheets using x-axis (left-to-right) and y-axis (top-down) coordinates, with respect to the top-left corner of the sheet.

In one embodiment of the present invention, an end-user can view a shape on a display, such as a computer monitor, a kiosk screen, the screen of a personal data assistant or other digital device. The shape may correspond, for example, to a complex label shape. After the user has customized and/or personalized text, graphics or other information to be printed, the software may apply a rotation to the shape as it is referenced onto the page to be printed.

As one non-limiting example of an application of the present invention, a sheet and formatting system for printing a compact disc (CD) spine and case insert may be provided. To the end-user who is customizing and/or personalizing the spine and case insert, the spine may appear lengthwise across the display screen when viewed by the end-user, who would typically add text and/or graphics onto the spine. But, for purposes of printing, the system rotates the shape of the spine so that the spine is standing tall with respect to the printed sheet and the text is sideways. That is, the system rotates the shape and/or text, graphics and the like prior to printing, to properly map the information onto the product to be printed.

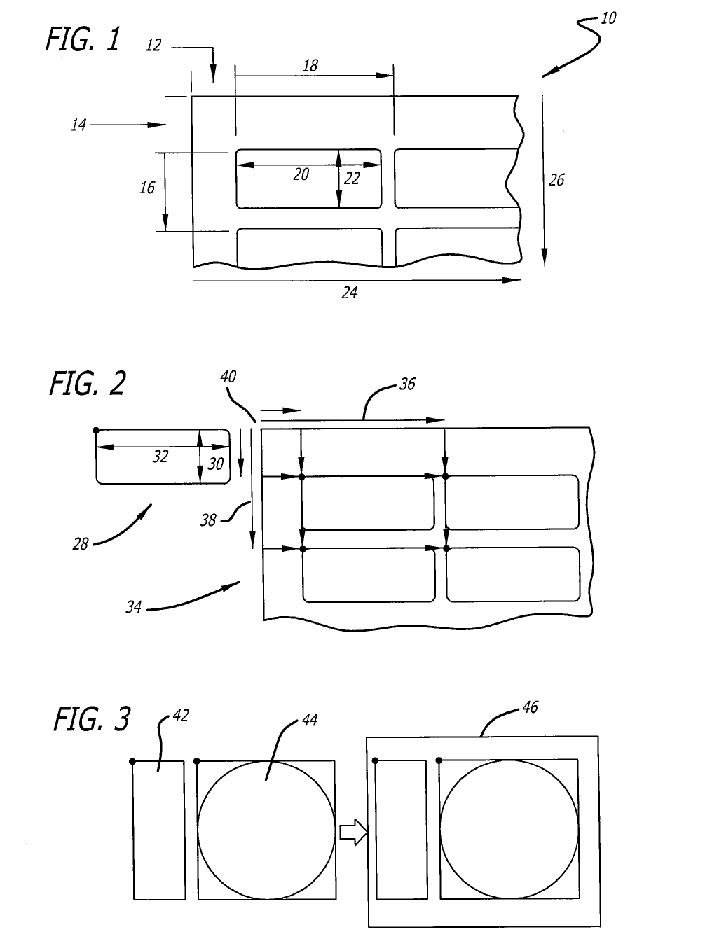

FIG. 2 illustrates page demarcations defining virtual shapes that are separate from the sheet itself. In this instance, the virtual shape corresponds to a rectangular label 28 having a height 30 and a width 32. The virtual shapes are referenced to the sheet 34 in terms of x-axis coordinates 36 and y-axis coordinates 38 referenced from the top left corner 40 of the sheet. The reference point can be a location on the sheet other than the top left corner, such as the top right corner or another location, with the coordinate system changing accordingly as the reference point changes. Also, there is no rotation of the virtual shape in this particular example, but rotation could be specified if desired.

This approach provides far more flexibility as compared to the table and pitch approach. For example, different panels (or “virtual shapes”) can be referenced to one or more sheets. Unlike the prior art table and pitch approach, these panels can be any shape bounded within a rectangle. FIG. 3 illustrates a first shape 42 and a second shape 44 referenced onto a sheet 46.

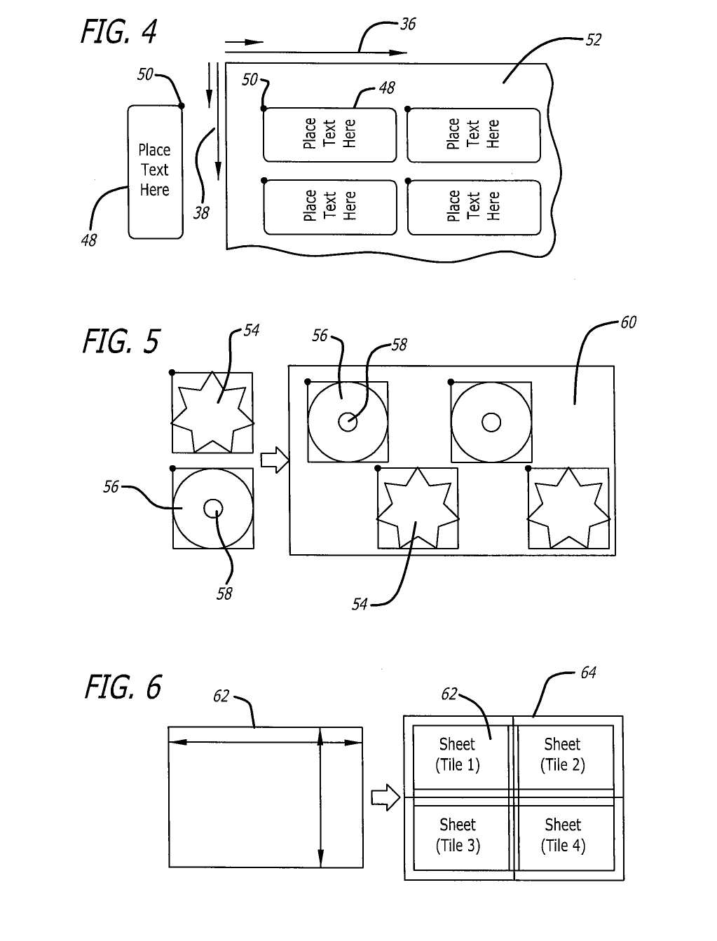

Beside the x-axis and y-axis, panels are also referenced to a sheet using rotation. However, the positioning of the shape on the page does not change. Instead, the rotation adjustment is applied by swapping the width and height which has the effect of repositioning the coordinate point on the virtual shape. Simultaneously, the reference point on the page then moves clockwise from corner to corner of the rectangular bounding box of the virtual shape. This gives the appearance that the content on the sheet is being rotated. FIG. 4 illustrates a virtual shape 48 having a coordinate point 50. The virtual shape 48 is rotated 90° clockwise when referenced onto a sheet 52. In one embodiment, panel rotation is only applied in 90° increments, and consequently can be done by swapping width and height of the virtual shape in conjunction with the page reference points.

A rotation of 180° can also be applied. However, in this case the width and height of virtual shape are not swapped. The reference point on the page is moved to the opposite corner of the virtual shapes bounding box. Like 90°, a 270° rotation does require a virtual shape width height swap as the page reference point continues to moves clockwise around the bounding box of the virtual shape. The page orientation (portrait or landscape) can also be swapped following similar logic. The page corner used by the reference points is simply moved. More complex methods of panel rotation can be implemented such as, for example, using known matrix-based rotation algorithms. The rotation may also be 0° for cases in which there appears to be no rotation. A template may explicitly define a rotation as 0° or, alternatively, if no rotation value is specified in the template, a default rotation value of 0° (or other value as appropriate to the application) may be assumed.

Panels can be far more complex than simple rectangular shapes. Panels can be ellipses and polygon shapes, for example, and can also include additional shapes within them to designate nonprintable area. These panels can be referenced many times on a sheet. FIG. 5 illustrates two such complex shapes: a complex star shape 54 and a complex circular shape 56 having a non-printable area 58. These shapes are referenced in a repeating fashion on a sheet 60.

These new demarcation instructions can also be used to combine pages (as tiles across and down) into a panel larger than a single sheet. The virtual shape can be divided into tiles where each tile carries the characteristic of the printable sheet. FIG. 6 illustrates a sheet 62 that is referenced a larger panel 64. In this way, a variety of signs, billboards, banners, posters, and other printed objects larger than a single sheet can be created by combining multiple printed single sheets. This concept is generally implemented, for example, in Avery Dennison's Sign Kit products. The sheets may overlap at the edges, or at whatever edges are appropriate as is known in the art, when being assembled to form the larger document. Appropriate software routines known in the art may be used to properly print images on individual sheets to account for the overlap in sheet edges.

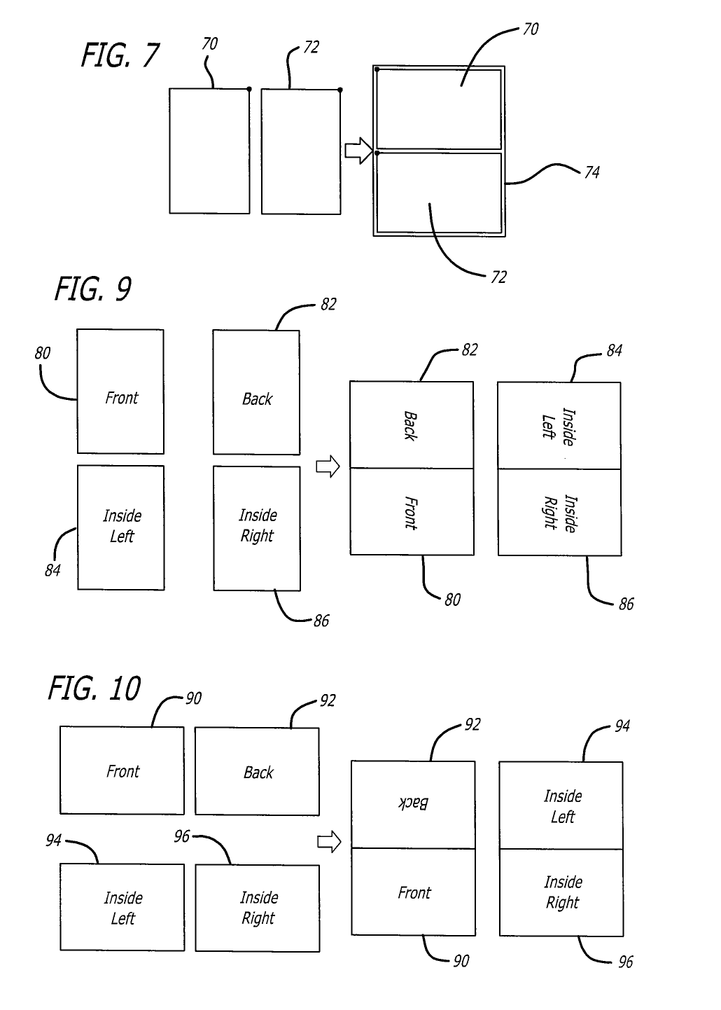

Other panels can be provided as additional virtual shapes. The other panels, which may have any panel shape, can then be assigned a priority. Separate from priority, the coordinates referencing one or more panels can be assigned an order on the page. FIG. 7 illustrates a first virtual shape 70 having a first priority, and a second virtual shape 72 having a second priority. Content is then added to the first virtual shape 70 first, and the first virtual shape 70 is referenced onto the sheet 74 first. The combination of priority and order allows an application to know which panel to add content to first and in what order to walk through the various shapes referenced on a sheet regardless of their reference locations on the sheet.

These and other options were not previously possible with the table and pitch method. The table and pitch method did not adequately describe multiple unique panels, complex shapes, rotation, page-orientation, tiling, priority or order. Programs wanting such functionality had to implement this thru detailed complex algorithms within the code.

With this new approach according to one embodiment of the invention, this functionality is described within the demarcation instructions and can be implemented through a standard set of rules. Unlike the table and pitch approach of the prior art, the present approach is complete and self-contained. The specification includes instructions for multiple pages, multiple panels, polygons, rotation page-orientation, tiling, priority and order. It also supports more complex functionality such as copy-and-paste rules, formatting instructions, arrangement patterns, transformation guidelines and linking to databases while continuing to provide backwards compatibility.

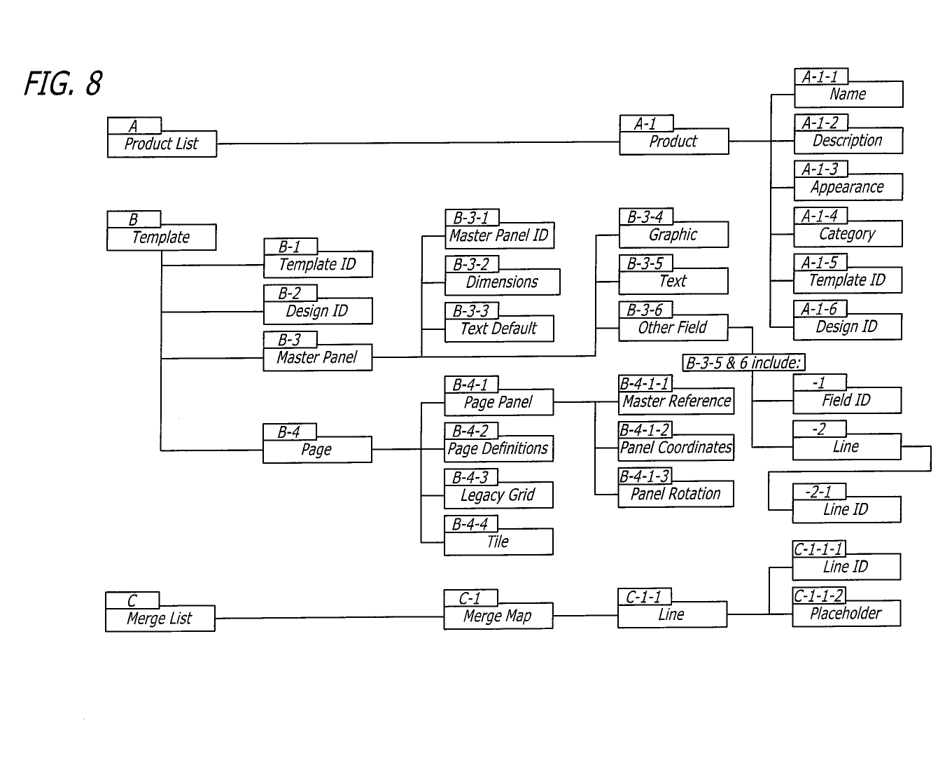

One embodiment of the present approach is summarized in FIG. 8. A Product List (reference A in FIG. 8) identifies individual printable media products (A-1). This is used to render a list for selection, evaluation or transformation. It includes information that is not specific to sheet demarcation like name (A-1-1), description (A-1-2), appearance (A-1-3) and categorization (A-1-4). The template ID (A-1-5) and Design ID (A-1-6) references the template that includes the proper demarcation instructions for that product.

A template (reference B in FIG. 8) has two basic functions. The first is to provide a blank template with a complete set of demarcation instructions. Secondly, to provide a method of adding text, graphics and other field objects for use as a pre-designed sample. A template may include such information as dimensions of and/or other information about the actual sheet, as well as locations on the sheet where virtual shapes are to be located and default text properties, such as text orientation. In one specific implementation, the template is written in XML, although other languages known in the art may be used. Nonlimiting examples of other information that may be provided in a template include text typeface, point size, justification, alignment, size of text blocks, rotation of text blocks, and paper size. Other information may be included as desired. A sample template is attached as Appendix A for purposes of nonlimiting illustration.

The virtual shape is called a master Panel (B-3) and the assignment of that shape into a sheet—using panel coordinates (B-4-1-2)—is called a page panel (B-4-1).

A Template ID (B-1) is the reference to a blank template. The Template ID can be provided as the name of a blank template file or as an internal ID. Each blank template includes specific demarcation instructions.

A Design ID (B-2) references a pre-design template. The Design ID can be provided as a code for grouping like product or other internal ID within a template file. Pre-design templates provide the same demarcation instructions included in a blank, but with added sample text, graphic and other content based on product use and design aesthetics.

A Merge Map (C-1) identifies the arrangement of lines or assignment of objects within a blank or pre-design template. The merge Map lines (C-1-1) can be applied to a blank template that references a specific merge map name, or the merge map line IDs (C-1-1-1) can be assigned as line IDs within pre-design templates. Merge Maps allow data source references to be included as content assignment instructions.

In operation, and in one embodiment of the invention, a product list is provided on which the relevant product identification codes are listed, from which an end-user chooses. A key field links the template and the product identification codes. When the end user selects a product from the product list, a specific product group code is associated with the product. The product group code references a specific set of templates designed to exactly match the chosen product sheet.

Example of Operation of the System:

Worldwide Specification Database

Considering now one example of the operation of a system according to an embodiment of the present invention, the virtual shape and demarcation instructions may be used to consolidate a variety of independent specifications and application-centric definitions into a single repository.

This includes establishing a central product specification database containing all of a manufacturers' printable sheet specifications. This is typically not a database used to capture the machining process for manufacturing, but is specific to the needs and characteristics necessary to output templates in this format for editing and printing within software applications.

Such a database may be used to store and output a company's template specifications. The database may include such data as:
SKU: an alpha-numeric identifier representing the actual SKU, UPC or other product code
Product description: name, categorization and/or other explanatory information
Product layout: geometry and other attributes defining and/or affecting layout
Output Rules: guidelines needed to output the templates

This information can be used in a number of ways. For example, it may be used to generate a product list and templates to be used in the company's own software applications. It may provide product information and layout to third party partners. It may also provide “same-as” classifications for all SKUs that use the same template. Such a database may substantially reduce a company's internal maintenance and administration costs.

Benefits of such a database may be further appreciated in contexts in which a company's printable sheet products extend across various languages and/or paper sizes and types. A single common definition is provided for layout related to formatting and printing for all of a company's printable sheets worldwide, across languages and various paper types—including: North American, International standards (ISO 216/DIN 476) and extensions, custom sizes and continuous feed, for example.

Example of User Advantages:

Applying Text and Graphics to Virtual Shapes

This present invention may be implemented to provide a consistent approach to applying text and graphics to a large variety of unique printable sheets, while making difficult shapes easy for consumers to edit. Many different virtual shapes can be viewed and formatted with great consistency, and then assembled together for printing, with minimal effort on the part of the consumer.

For example, in one embodiment of the present invention, the (1) front, (2) back, (3) inside left and (4) inside right of a greeting card can be viewed and formatted shape by shape. When printing, the sheet is then assembled by applying the user's text and graphics, following the demarcation rules. The rotation is removed when editing yet applied when printing. The complexity of the system is hidden from the end user. FIG. 9 illustrates shapes for a front 80, a back 82, an inside left 84 and an inside right 86 of a greeting card. When prepared for printing, the shapes are rotated as illustrated. It should generally be understood that FIG. 9 illustrates the front and back of a single sheet, which is typically run through a printer twice, for printing on each side.

Additional templates can be provided for the same printable sheet. For example, a greeting card having sections corresponding to those of the embodiment of FIG. 9, can also be presented in a “wide” version. FIG. 10 illustrates shapes for a front 90, a back 92, an inside left 94 and an inside right 96. In this “wide” version, the width and height of each virtual shape is flipped when presented for formatting. A different rotation is also applied for printing.

With these templates, an end user can select a “Tall” or “Wide” version without having to worry about the rotation, page assembly and other complexities. Other applications capable of performing this task typically do this by applying application-centric logic in their code and/or configuration. To support new products, each application must be extended or reconfigured. Consumers then wait for software updates to be distributed.

This new approach is application-agnostic. All the logic needed to support these features is encapsulated within an external specification. When new and innovative printable sheets are introduced, applications that read the specification will immediately benefit. As such, customers are able to use the same software to format a large variety of products without having to learn any new processes or wait for new versions of the software.

As discussed previously, the present approach supports a large variety of complex printable sheets. This is achieved by consolidating various layout, formatting and printing requirements into a single external text-based template specification. This may include unique layout and other printable sheet characteristics found in products like audiotape labels, banners, binder spines, brochures, burst labels, business cards, CD/DVD labels, color coding labels, computer diskette labels, decals, display boards, divider tab labels, divider inserts, filing labels, greeting cards, ID cards, index cards, jewel case inserts, mailing labels, mailing seals, name badges, notary seals, note cards, photo paper, pin-fed labels, pin-fed name badges, postcards, posters, rotary cards, round labels, shipping labels, signs, stickers, tables of contents, tape reel labels, tent cards, transparencies, t-shirt transfers, video tape labels and many other card and label products.

Previous approaches could not format and print with the consistency and accuracy of the present approach. The formatting details of printable sheets is now well described in a single application-agnostic specification.

The following are a few examples of how virtual shapes and page demarcation will benefit consumers when adding text and graphics using software applications.

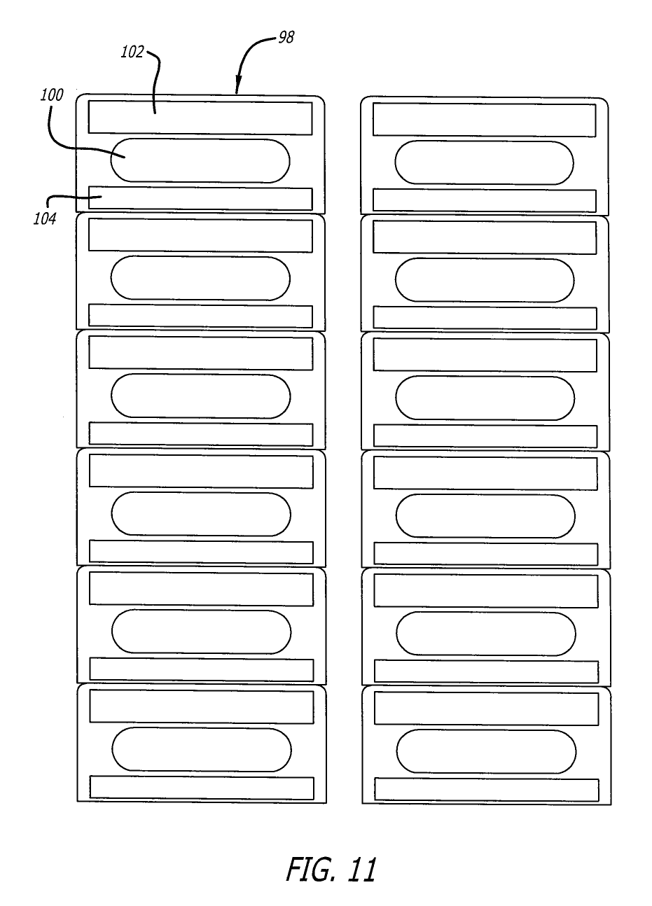

Audiotape Labels: FIG. 11 illustrates a form for an audio label 98 that has an area denoting the cutout 100, which is an open area showing tape position within the cassette, and providing for multiple areas for text input such as 102 and 104. Software applications using this specification may display a preview version of the final product. The end user can then see whether text and/or images fit properly on the label, whether any text is cut-off (as in areas where there is a cut-out) or the like. The end-user can also add an image, for example, and know whether a portion of the image will be cut off due to the audiotape label boundary and internal cutout.

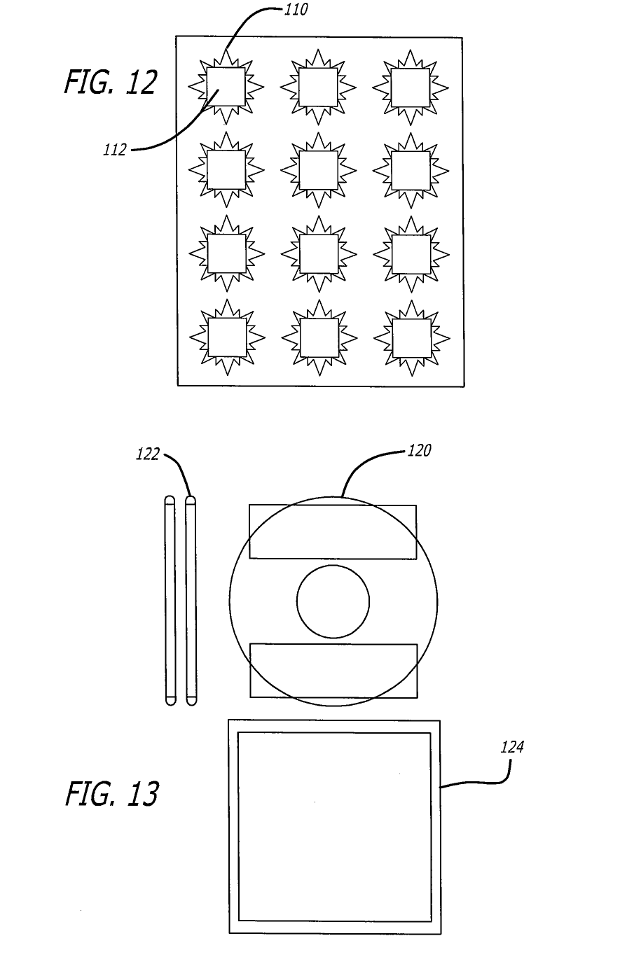

Burst Labels: FIG. 12 illustrates polygon shapes 110 that are positioned on a printable sheet. Consumers can apply a graphic background and see the positioning and waste rendered from the unusual shape of any polygon. The best position for text 112 is also suggested Areas for text may be defined within a subshape. This ensures that text will not stray outside of the shape.

CD/DVD Labels and Inserts:

Various shapes and sizes, with rounded or square corners, having cutouts and different rotations can all be rendered on a single printable sheet providing the consumer with simple guidelines for adding test and graphics while guaranteeing print accuracy. For instance, as illustrated in FIG. 13, this approach can be used to define CD/DVD labels 120, spine labels 122 and jewel case inserts 124.

Mini-Media Labels:

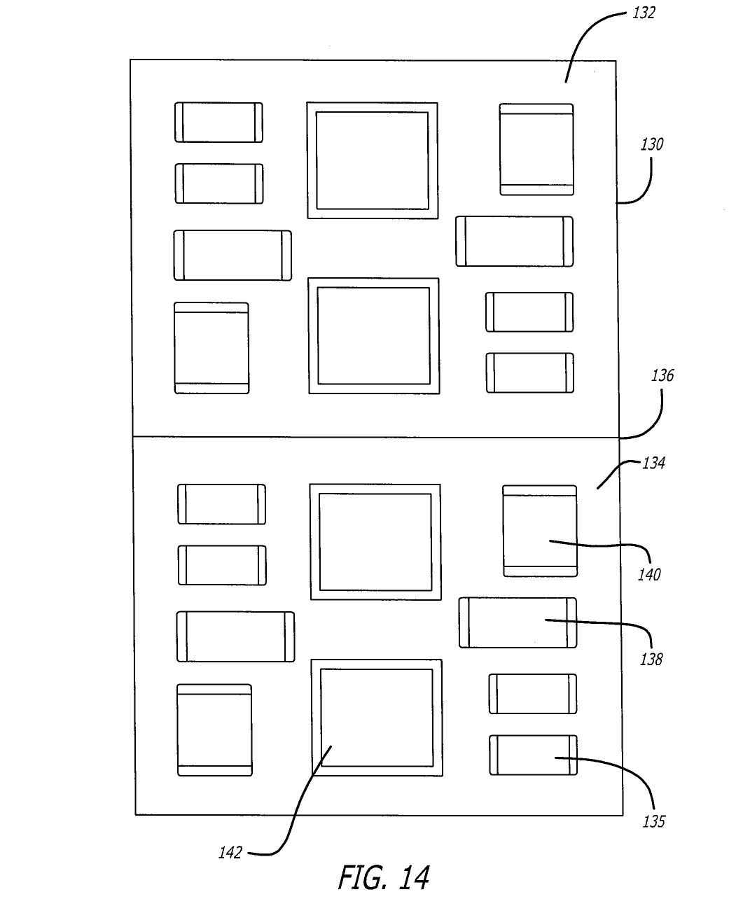

Another example of a sheet that can be defined using the present approach is to provide a printable sheet that includes multiple virtual shapes for smartmedia, memory stick, SD card and compact flash labels. The specific example in FIG. 14 is in a “mini-sheet” format, in which a sheet 130 has two halves 132 and 134, divided by a line of perforations 136. Shapes may define smartmedia labels 135, memory stick labels 138, SD card labels 140 and compact flash labels 142. FIG. 14 illustrates that a large variety of different shapes can all be combined on a single printable sheet. The order of these shapes is set up to walk the user through easy formatting.

Round Labels: FIG. 15 illustrates a 4″×6″ index size sheet containing round labels offset in each row. Text boxes are provided in which text and/or graphics can be placed by the end-user. The text boxes are provided to best fit the characteristics of the printable areas of the shapes or allow for variations in the print placement. The squares in FIG. 15 may be, for example, text boxes. As can be seen, the present invention provides virtually an endless variety of shapes and positioning, but more importantly orders and presents them for easy formatting.

Example of Extensibility:

The present invention may be extended to provide “hints” for supporting advanced data handling as the hosting software is improved from one revision to the next. Information beyond the geometry of a printable sheet can be used to enhance the users' experience. Hints may be supported to indicate alternative means of formatting virtual shapes. Hints can be used to add or extend functionality, but the specific hint values are typically not part of the base specification. Different hints can be added and taken away without altering the virtual shape and demarcation instructions.

Six (6) basic reasons why hints may be supported are:

1. Providing conversion tools with transformation guidelines;

2. Providing references and additional processing instructions during conversion;

3. Enabling product-based features in specification-aware applications;

4. Enabling application functionality for formatting different types of products;

5. Enabling additional architectural solutions beyond template geometry; and

6. Holding temporary data when templates are used to convey data from one segment of software to the next

Transformation hints may be provided as instructions used by conversion utilities to override their internal transformation rules.

Converters implement their own set of business rules specific to their target application. For example, one application may only support single page templates and will use the first page only, unless otherwise notified. These transformation hints can be used to identity when business rules are applied or overridden. For example, a hint may suggest using page 2.

Beyond conversion, hints can also be used within specification-aware applications. For example, a printable sheet may have some unique formatting requirement. A product-based hint may be needed in order to execute product related functionality. In some cases, the functionality is more specific to a particular application versus the printable sheet. Functionality hints can be added to alter the flow of an application. Virtual shape and demarcation instructions are application agnostic, but a hint value may not be. That is, the value of a hint may be application-specific. In this way, a hint becomes part of a larger architectural solution. These architectural hints are not the entire solution, but a switch to activity the larger architectural solution. The concept of “hints” is generally known in the art, although not in conjunction with virtual shapes as discussed herein.

Support for Double-Sided Printing

A number of products are designed to be printed on more than one side. This includes, for example, certain greeting cards, business cards, brochures, and other applications in which printing is to appear on more than one side. Formatting for such products can be somewhat complicated as compared to products that are printed on only one side.

The present invention permits new double-sided products to be introduced, without having to re-write the code of the software itself. Sheet specifications for sheets on which double-sided printing is to be performed can now be provided to software by way of templates, without the need to rewrite the software itself. That is, the present approach supports the proper rotation and placement of the panel(s) with respect to a new end product, and can also define an appropriate rotation, without having to update the software itself.

Considering this aspect in more detail, the virtual shape and demarcating instructions accurately represent both sides of the printable sheet while supporting a consistent approach for printing instructions. This includes support for three different views:

1. Shape view—how one looks at a shape when adding text and graphics—wide or tall, for example

2. Default view orientation—how the sheet is to be previewed

3. Printer feed—how the sheet is initially fed, and then reinserted, in the case of a double-sided sheet, into a printer

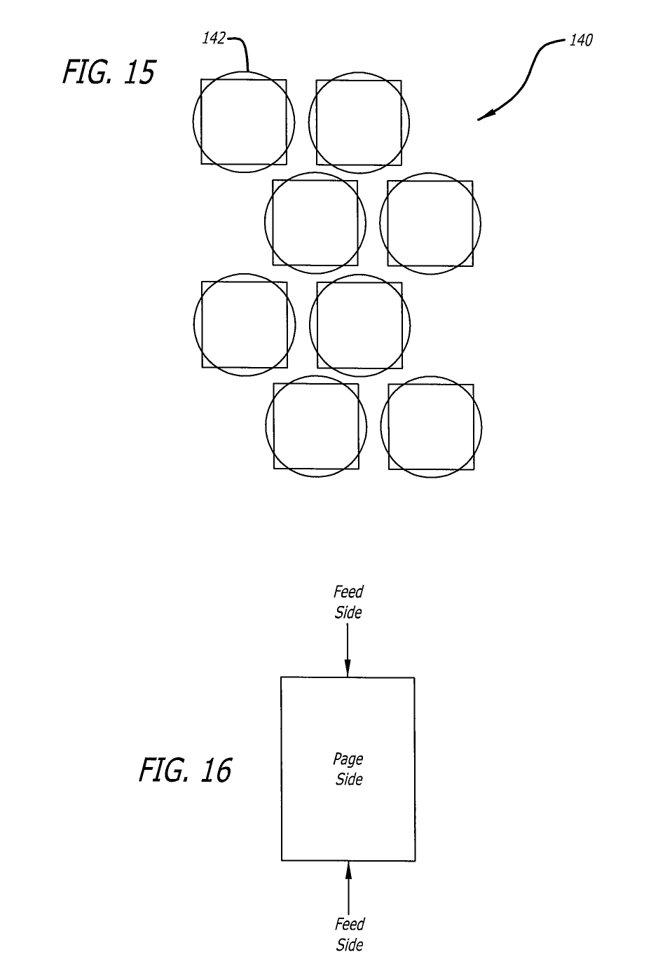

Double-sided printable sheets typically include various shapes at various rotations, and must be correctly reinserted into the printer for printing of the second side. Regardless of the orientation of a design, these printable sheets are always fed and reinserted into the printer as a portrait sheet. Different printers each have their own unique requirements for printing. This includes identifying the correct page-side and feed-side for reinsertion, as FIG. 16 illustrates.

Re-feeding of the page side depends on the printer, and is not specifically addressed here. Printing instructions are provided to ensure that the content of the second side is not accidentally printed over the content of the first side. However, the feed side is specific to the arrangement of shapes and demarcation instructions applied on the second side of the printable sheet. Most double-sided products will then need some specific instructions for reinsertion to print the second side.

Further modifications and improvements may additionally be made to the device and method disclosed herein without departing from the scope of the present invention. Accordingly, it is not intended that the invention be limited, except as by the appended claims.

What is claimed is:

1. A computer-implemented method for positioning text and/or graphics on a sheet, comprising the steps of:
defining a virtual shape; and
referencing the virtual shape to a sheet using coordinates and rotation.

2. A computer-implemented method as defined in claim 1, wherein the method further comprises the steps of:
displaying the virtual shape to an end-user in a first orientation; and
referencing the virtual shape to a sheet in a second orientation that is different than the first orientation.

3. A computer-implemented method as defined in claim 1, wherein the shape comprises a complex polygon.

4. A computer-implemented method as defined in claim 1, wherein the shape comprises an ellipse.

5. A computer-implemented method as defined in claim 1, wherein the step of referencing the virtual shape comprises referencing the virtual shape with respect to at least one of: a top-left corner of the sheet, a bottom-left corner of the sheet, a top-right corner of the sheet, and a top-left corner of the sheet.

6. A computer-implemented method as defined in claim 1, wherein the method further comprises:
defining multiple virtual shapes; and
referencing the multiple virtual shapes to a sheet using coordinates and rotation.

7. A computer-implemented method as defined in claim 6, wherein each virtual shape is assigned respective coordinates and rotation.

8. A computer-implemented method as defined in claim 6, wherein the multiple virtual shapes include different virtual shapes.

9. A computer-implemented method as defined in claim 1 wherein the virtual shape is larger than an actual printed sheet.

10. A computer-implemented method as defined in claim 1 wherein the virtual shape comprises multiple virtual subshapes.

11. A computer-implemented method as defined in claim 7, wherein a first virtual shape has a first rotation and a second virtual shape has a second rotation, the first rotation being different than the second rotation.

12. A computer-implemented method as defined in claim 1, wherein the step of defining a virtual shape includes defining at least one non-printable area on the virtual shape.

13. A computer-implemented method as defined in claim 1, wherein the step of referencing the virtual shape to a sheet using coordinates and rotation comprises repositioning a coordinate point.

14. A computer-implemented method as defined in claim 2, wherein the method further comprises the steps of:
receiving input from an end user comprising at least one of text and graphics;
displaying the input on a display;
referencing a virtual shape and the input together onto a sheet.

15. A computer-implemented method as defined in claim 14, wherein the method further comprises the step of printing the sheet.

16. A computer-implemented method as defined in claim 15, wherein the method further comprises defining multiple virtual shapes and referencing the virtual shapes and input onto a sheet.

17. A computer-implemented method as defined in claim 16, wherein the multiple virtual shapes include different virtual shapes.

18. A computer-implemented method as defined in claim 14 wherein the virtual shape is larger than an actual printed sheet.

19. A computer-implemented method as defined in claim 14 wherein the virtual shape comprises multiple virtual subshapes.

20. A computer-implemented method as defined in claim 14, wherein the method further comprises defining multiple virtual shapes and referencing the virtual shapes and input onto multiple sheets.

21. A computer-implemented method as defined in claim 14, wherein the method further comprises the steps of:
defining a product list that identifies individual printable media products; and
correlating at least one virtual shape, coordinates and a rotation with at least one entry on the product list.

22. A computer-implemented method as defined in claim 21, wherein the method further comprises:
receiving identification of a product from the product list from an end user;
receiving input from the end user comprising at least one of text and graphics; and
referencing a virtual shape and the input to the product selected by the end user.

23. A computer-implemented method as defined in claim 22, wherein the method comprises referencing the virtual shape multiple times onto the sheet.

24. A computer-implemented method as defined in claim 22, wherein the virtual shape includes an open area and multiple areas for text input.

25. A computer-implemented method as defined in claim 22, wherein the method comprises:
referencing the virtual shape onto a single sheet at multiple locations on the sheet, at a different location on the sheet each time; and
printing the sheet.

26. A computer-implemented method as defined in claim 21, wherein a first virtual shape corresponds to a spine, a second virtual shape corresponds to a jewel case insert and a third virtual shape corresponds to a CD/DVD label.

27. A computer-implemented method as defined in claim 20, wherein the multiple shapes comprise at least two of shapes corresponding to: a smartmedia label, a memory stick label, an SD card label, and a compact flash label.

28. A computer readable media capable of causing a general purpose computer to implement the method of claim 1.

29. In a computer system that positions virtual shapes, text and/or graphics for printing on a sheet, the computer system comprising: a means for defining properties of a printable sheet; a means for defining locations on the sheet where virtual shapes are to be located; a means for defining rotation of virtual shapes for placement onto the sheet; and a means to print the printable sheet in which at least one of a virtual shape, text and graphics are printed onto the sheet in accordance with defined locations and rotations.

30. A computer readable medium having computer executable instructions stored thereon for formatting a document for printing, the executable instructions comprising:
instructions for displaying a virtual shape on a display to a user;
instructions for receiving input from the user;
instructions for acquiring information defining a printable sheet, a position on the printable sheet corresponding to the virtual shape, and a rotation of the virtual shape on the printable sheet; and
instructions to print a printable sheet formatted based at least in part on input from the user and the information defining the printable sheet, the position information and the rotation information.

31. A computer system comprising:
a digital processor coupled to computer memory, the computer memory comprising software including:
instructions for displaying a virtual shape on a display to a user;
instructions for receiving input from the user;
instructions for acquiring information defining a printable sheet, a position on the printable sheet corresponding to the virtual shape, and a rotation of the virtual shape on the printable sheet; and
instructions to print a printable sheet formatted based at least in part on input from the user and the information defining the printable sheet, the position information and the rotation information.

32. A computer-implemented method for positioning text and/or graphics on a sheet, comprising the steps of:
defining a virtual shape;
referencing the virtual shape to a sheet using coordinates and rotation;
displaying the virtual shape to an end-user in a first orientation; and
referencing the virtual shape to a sheet in a second orientation that is different than the first orientation;
wherein the shape comprises a complex polygon;
wherein the step of referencing the virtual shape comprises referencing the virtual shape with respect to at least one of: a top-left corner of the sheet, a bottom-left corner of the sheet, a top-right corner of the sheet, and a top-left corner of the sheet;
wherein the step of defining a virtual shape includes defining at least one non-printable area on the virtual shape;
wherein the step of referencing the virtual shape to a sheet using coordinates and rotation comprises repositioning a coordinate point;
wherein the method further comprises the steps of:
receiving input from an end user comprising at least one of text and graphics;
displaying the input on a display; and
referencing a virtual shape and the input together onto a sheet.
